(19) United States
(12) Patent Application Publication
(10) Pub. No.: US 2008/0044661 A1
(43) Pub. Date: Feb. 21, 2008

(54) Isocyanate Composition Comprising a Vegetable Oil and Composites Therefrom

(76) Inventor: David M. Hazell, Georgetown (CA)

Correspondence Address: The Dow Chemical Company, Intellectual Property Section, P.O. Box 1967, Midland, MI, 48641-1967, US

(21) Appl. No.: 11/720,090

(22) PCT Filed: Dec. 15, 2005
(86) PCT No.: PCT/US05/45389

§ 371 Date: May 24, 2007

Related U.S. Application Data
(60) Provisional application No. 60/638,721, filed on Dec. 23, 2004.

(51) Int. Cl. C08G 18/10; B27N 3/00; C08G 18/18; C08K 5/103; C08L 75/04; C08G 18/20; B29C 43/00

(52) U.S. Cl. 428/423.1; 528/1

(57) ABSTRACT

The present invention relates to an isocyanate composition comprising vegetable oil and use of the said composition as a moisture-curable binder when preparing molded composite articles from particulate material. More particularly the invention relates to an isocyanate composition containing a methylene diphenylisocyanate prepolymer and as vegetable oil, soybean oil; and the use of such composition as binder for formation of rubber crumb composites.

The present invention relates to an isocyanate composition comprising vegetable oil and use of the said composition as a binder when preparing molded composite articles from particulate material.

Polyurethanes are found in a broad spectrum of applications functioning in a variety of roles; one such role is as binder for particulate matter. The particulate matter can be, for example, sand when concerned with foundry applications; lignocellulose particles when concerned with wood board; reground foam when concerned with foam recycle activities; or other ground plastics and rubber when concerned with matting and flooring etc. Typically the polyurethane binder system is compounded with the particulate material and the resulting mass shaped or molded prior to curing out to give the final product. The polyurethane binder system may be a two-component system or alternatively a one-component system.

By two-component it is understood two streams, typical an isocyanate stream and a isocyanate-reactive composition (e.g. polyol) which on intimate mixing with one another provides a reactive mass that cures to a polyurethane resin. Compounding of the two-component binder with the particulate matter and any subsequent manipulation must be accomplished before the system is fully cured. By one-component system it is understood a single stream that on exposure to moisture or external energy source, such as electromagnetic radiation or heat, cures to form a polyurethane. Typically one-component systems are isocyanate-terminated prepolymer compositions. Isocyanate-terminated prepolymer compositions by nature of their chemical make-up are frequently of elevated viscosity which in itself can present difficulties for their compounding with particulate matter in the limited processing times available. To alleviate this problem it is common practice to include, non-reactive organic solvents, including petroleum or naphthenic oils such as described in US Patent application US 2002/103289, as viscosity cutting or viscosity reducing agents. Such solvent typically is lost to the environment during subsequent processing steps.

Every increasing concern for the well being of the environment has prompted the present investigation directed to identifying alternative substances that can permit the avoidance of the commonly used volatile viscosity cutting agents or naphthenic products in one-component polyurethane binder systems. To this purpose, an object of the present invention is to utilize naturally occurring materials for use as viscosity reducing agents for one-component isocyanate-based compositions without adversely affecting the reactivity of such a one-component system.

In a first aspect, this invention relates to an isocyanate composition which comprises, based on total weight of the system:
a) from 50 to 95 weight percent of an isocyanate-terminated prepolymer composition having an average isocyanate content of from 1 to 15 weight percent, and
b) from 5 to 50 weight percent of a vegetable oil characterized by substantial absence of terminal functionality able to react with the isocyanate moiety of the prepolymer.

In another aspect, this invention is a mixture suitable for compression molding or pour-in-place casting which comprises, based on total weight of the mixture:
a) from 75 to 95 percent of elastic or inelastic particles wherein the particles are of a size range of 0.1 to 15 mm,
b) from 5 to 25 percent of a moisture-curable isocyanate composition containing
   i) from 50 to 95 weight percent of an isocyanate-terminated prepolymer composition having an average isocyanate content of from 1 to 15 weight percent, and
   ii) from 5 to 50 weight percent of a vegetable oil characterized by a substantial absence of terminal functionality able to react with the isocyanate moiety of the prepolymer

In yet another aspect, this invention relates to a process of forming a compressed cured material from a mixture comprising:
a) 75 to 97.5 weight percent of elastic or inelastic particles wherein the particles are of a size range of 0.1 to 15 mm; and
b) 2.5 to 25.0 weight percent of a polymer binder, said process characterized in that the polymer binder is a moisture curable isocyanate composition containing
   i) from 50 to 95 weight percent of an isocyanate-terminated prepolymer composition having an average isocyanate content of from 1 to 15 weight percent, and
   ii) from 5 to 50 weight percent of a vegetable oil that is substantial devoid of terminal functionality able to react with the isocyanate moiety of the prepolymer.

In a preferred embodiment the particles are of a substance selected from the group consisting of granulated rubber, polymerized ethylene-propylene diene, neoprene, granulated cork, granulated polyvinylchloride, granulated polyurethane, and granulated sawdust.

In yet another aspect this invention is a composite article comprising particulate matter bound together by a cured polyurethane resin wherein said polyurethane resin is obtained by moisture curing of the isocyanate composition as mentioned above.

The vegetable oils are found to be effective viscosity reducing agents and diluents in isocyanate compositions intended for moisture-curable composite binder applications thereby permitting avoidance of commonly employed solvents that are less desirable from an environmental and industrial hygiene aspect.

The isocyanate composition of this invention is characterized in that it comprises an isocyanate-terminated prepolymer and a vegetable oil. The composition based on total weight of prepolymer and vegetable oil present contains the prepolymer in an amount of from 50 to 95, preferably from 55 to 90, and more preferably from 60 to 90 weight percent. Commensurately the vegetable oil is present in an amount of from 5 to 50, preferably from 10 to 45, and more preferably from 10 to 40 weight percent.

For the purpose of this description the term “vegetable oil” collectively refers to oils obtained from naturally grown, plant sources but notably from plant crops or seeds. Vegetable oils are typically a complex mixture of fatty acid esters derivatives of; the reader is referred to literature sources such as, for example, the Chemical Handbook or Kirk Othmer Encyclopedia of Chemical Technology for a more detailed discussion on the composition of vegetable and seed oils including the entry entitled “Soybean and other oil seeds” p. 591, Vol 22 (4^{th} Edition). The vegetable oil as utilized within the present invention is characterized by being devoid or having a substantial absence of terminal functionality able to undergo reaction with the isocyanate moiety of the prepolymer. Such functionality is mostly moieties containing active hydrogen atoms such as associated with hydroxyl, amine or carboxylic acid moieties and such like. Presence of such functionality can be observed through the test procedure ASTM D4274. Presence of such functionality can give inappropriate reaction with the isocyanate rendering the composition less suited to use in the intended binder application. It is also to be noted that the vegetable oil should be essentially free of water or moisture content to avoid inadvertent foaming in binder applications. Moisture content can be monitored by the test procedure ASTM E203. By the term substantially free of moisture, or isocyanate-reactive functionality it is meant amounts of less than about 0.15, preferably less than about 0.1, and more preferably less than about 0.08 percent. In a preferred embodiment of this invention, the vegetable oil can additionally be characterized in that it is rich in the unsaturated fatty acid ester derivatives based on linolenic acid or linoleic acid. By “rich” it is understood that such unsaturated acid derivatives constitute at least 50 weight percent of the oil.

In the present invention exemplary of suitable oils are soybean, safflower, corn, sunflower, linseed, coconut, cottonseed, palm, olive, rape, grape and peanut oils and mixtures of two or more thereof. Exemplary of the preferred oils, noted with what is appreciated as being their approximate unsaturated fatty acid content (generally linoleic unless otherwise noted) are corn (57.5 percent), cottonseed (54.2), safflower (77.4), sunflower (67.5), soybean (55.8) and linseed (60.6 linolenic content). Especially preferred is soybean oil which facilitates to advantage the processing and use of such isocyanate composition in moisture-curable binder applications.

The isocyanate-terminated prepolymer component of the isocyanate composition may be any prepolymer as known or considered suitable for use in the intended end application. Polyols used for the production of the isocyanate-terminated prepolymers are compounds which contain two or more isocyanate reactive groups, generally active-hydrogen groups such as —OH, primary or secondary amines, -SH and —COOH. Representative of such polyols a generally known, see for example, “Polyurethane Handbook”, by G. Oertel, Hanser publishers; High Polymers, Vol. XVI; Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). Representative of suitable segments include polyester, polylactone, polyether, polyolefin, polycarbonate polyols, and various other segments.

Preferably the polyol is a polyether or polyester and more preferably a polyether. Preferably the active-hydrogen group reactive with isocyanate is a hydroxyl. Generally the polyol has an equivalent weight of from 500 to 3,000 and preferably from 700 to 2,500.

Commonly used prepolymers for binder applications in this instance are those obtained by reaction of an excess of an aliphatic or aromatic polyisocyanate, such as toluene diisocyanate or methylene diphenylisocyanate, with a polyol and wherein the resulting product has an average free isocyanate content of from 1 to 18, preferably from 3 to 15, and more preferably from 5 to 15 weight percent. Preferably isocyanate prepolymers obtained from reaction of an excess of a methylene diphenylisocyanate with a polyether diol or triol is particularly suitable for use in admixture with the vegetable oil in binder applications. Such suitable isocyanate prepolymer compositions are commercially available, for example, VORAMER* MR 1102 or VORAMER MR 1105 industrial adhesives and binders (*Trademark of The Dow Chemical Company).

A particularly preferred isocyanate composition resulting from this present investigation is one which comprises a methylene diphenylisocyanate-based prepolymer having an isocyanate content of from 1 to 15 weight percent in admixture with as vegetable oil, preferably soybean oil.

The above described compositions are rendered moisture curable by the addition of small amounts of highly catalytic substances such as amines or silanes. Such catalytic substances are well known in the art, and recognized for their ability to promote the reaction of the isocyanate moiety of the prepolymer with water or steam to which it may subsequently become exposed. Exemplary of such an amine catalyst is dimorpholinodiethylether (DMDEE) available from Huntsman Chemical Company.

To render the above described composition suitable for certain types of binder applications it can be of advantage to further include dyes or pigments within the composition or other additives including combustion retardants, UV stabilizers or plasticizers. To minimize risk or potential of fungal or microbial growth it can also be of advantage to incorporate a broad spectrum biocide within the composition, especially when in the environment of the end application there can be potential for such undesirable growths.

The described isocyanate composition extended with vegetable oil, when compounded with a particulate matter, functions as polymer binder to give composite articles via pour-in-place casting or compression molding processes. Compounded mixtures suitable for preparation of composite articles typically comprise, based on total weight of the mixture, the particulate matter in from 75 to 97.5 weight percent based, and the isocyanate composition as extended with vegetable oil in from 2.5 to 25 weight percent.

The particulate matter is usually an elastic or inelastic particle of a substance such as granulated rubber (including styrene butadiene rubber), polymerized ethylene-propylene diene (EPDM), neoprene, ethylene vinyl acetate copolymer (EVA), granulated cork, granulated polyvinylchloride, granulated polyurethane, and granulated sawdust, wherein the particles are of a size range of 0.1 to 15 mm, preferably from 1 to 8 mm. Use of inorganic particulate matter such as sand or stone or concrete can also be used.

Procedures for the preparation or molded composite articles by pour-in-place casting or compression molding are well documented in the literature and will not be described in detail herein. For further details and discussion of such processes reference is made to, for example U.S. Pat. No. 5,151,230. In brief, for compression molding, such process can comprise placing the mixture in a mold and applying heat to the mold in a form of steam at a temperature between 110° C. and 140° C. and at a pressure between 3 to 8 bars and at a rate between 40 to 90 kg per hour to the mixture, and applying pressure of between 25 to 160 bars to the mixture to compress the mixture and effect a cure of the mixture and thus form the compressed cured material. Casting procedures generally do not involve such high temperature and elevated pressure. Illustrative of pour-in-place casting process are such as may be employed for sport track applications and as described in U.S. Pat. Nos. 6,159,550; 6,565,918; 5,472,743 or 5,514,722.

The isocyanate composition of this invention is found to have to specific utility and value in the preparation of composite articles such as roof or floor tiles from the binding of particulate rubber granules; in the preparation of certain component parts of a sports track or surfaces, playground surfaces or other types of recreational or hobby mats or flooring; in the preparation of composite articles used for traffic management including barriers, curbs, speed bumps and such like.

The following examples are given to illustrate the invention and should not be interpreted as limiting it in any way. Unless stated otherwise, all parts and percentages are by weight.

Isocyanate Compositions 1 to 6

Isocyanate compositions 1 to 6 are obtained by blending under dry conditions a soybean oil or a heavy naphthenic oil, in the proportions as given in the below table, with the isocyanate prepolymer composition VORAMER MR 1102 industrial adhesive and binder available from The Dow Chemical Company; described as the reaction product of a 50:50 mixture of 2,4- and 4,4-MDI reacted with a polyether diol and having an average isocyanate content of about 9.5 percent. The vegetable oil is super degummed Soybean oil from Ag-Pro of Massena, N.Y., USA and observed as having a moisture content of <0.10 percent (ASTM E203) and a OH functional content of ˜0 percent (ASTM D4274).

| | Isocya- | Isocya- | Isocya- | Isocya- | Isocya- | Isocya- |
|---|---|---|---|---|---|---|
| | nate 1 | nate 2 | nate 3 | nate 4 | nate 5* | nate 6* |
| VORAMER | 60 | 70 | 80 | 90 | 100 | 100 |
| 1102 | | | | | | |
| Soybean oil | 40 | 30 | 20 | 10 | 0 | 0 |
| Catalyst | 0.12 | 0.12 | 0.12 | 0.12 | 0.12 | N/A |
| Heavy | / | / | / | / | | 20 |
| naphthenic | | | | | | |
| oil | | | | | | |
| Viscosity | — | 585 | 820 | 1400 | 2410 | — |
| (Brookfield | | cps | cps | cps | cps | |
| LVT #2/12 | | | | | | |
| @30 C.) | | | | | | |

*Comparative Example
Catalyst: Morpholine, 4,4′-(oxydiethanediyl)bis, commonly referred to as DMDEE and available from Huntsman Chemical Company.

Composites 1 to 6 (“Pour-in-Place/Casting” Process):

The resulting isocyanate compositions are compounded with particulate styrene-butadiene buffings having an average particle size of about 15 mm to provide a mixture composed of about 82 weight percent particulate matter and about 18 weight percent of the isocyanate composition. Compounding is effected by mixing the isocyanate and rubber buffings in an open vessel and stirring for 3 minutes with a paddle mixer rotating at 1500 rpm. A sample of each compounded mixture, approx 610 g, is then placed in a mold having dimensions, 25.4 cm×23.1 cm×1.27 cm. The shaped article is removed from the mold after approx 6.5 minutes and the mass allowed to cure for 7 days at 23 C, 50 percent relative humidity prior to observing the tensile strength (test procedure ASTM D-412C) and elongation properties (ASTM D-412C) as reported below:

| | Compos- | Compos- | Compos- | Compos- | Compos- | Compos- |
|---|---|---|---|---|---|---|
| | ite 1 | site 2 | site 3 | site 4 | site 5* | site 6* |
| SBR | 82 | 82 | 82 | 82 | 82 | 82 |
| Isocyanate 1 | 18 | | / | / | | |
| Isocyanate 2 | / | 18 | / | / | | |
| Isocyanate 3 | / | / | 18 | / | | |
| Isocyanate 4 | / | / | / | 18 | | |
| Isocyanate 5 | / | / | / | — | 18 | |
| Isocyanate 6 | / | / | / | | | 18 |
| Tensile | 15.6 | 24.1 | 21.1 | 31.7 | 36.2 | 23.7 |
| Strength (psi) | | | | | | |
| Elongation | 28.0 | 42.0 | 48.0 | 40.0 | 50,0 | 26.0 |

*Comparative Example

Following evaluation of physical data of binder system vs level of vegetable oil present, further samples were produced. Samples were prepared in a 2′X2″X3″ mold, heated to 150° C. at 30 psi for 65 minutes.

Isocyanate Compositions 7-10 and Composites 7-10

To demonstrate the utility of this technology for manufacture of compression molded composites, the Isocyanate Compositions 7 to 10 are prepared as noted below from the same material as already described and subsequently compounded with SBR rubber to manufacture Composites 7 to 10 via a compression molding process.

| | Isocyanate 7 | Isocyanate 8 | Isocyanate 9 | Isocyanate 10* |
|---|---|---|---|---|
| VORAMER | 70 | 75 | 85 | 100 |
| 1102 | | | | |
| Soybean oil | 30 | 25 | 15 | 0 |
| Catalyst | 0.50 | 0.50 | 0.50 | 0.12 |
| (DMDEE) | | | | |

Molded composites are obtained from a mold having dimensions of approx 50 cm×50 cm×7.5 cm and heated to 150° C. at 30 psi for 65 minutes. The molded composite samples were removed and allowed to cure for 7 days at 23 C, 50 percent relative humidity prior to observing the tensile strength (test procedure ASTM D-412C) and elongation properties (ASTM D-412C) as reported below.

| | Composite | Composite | Composite | Composite |
|---|---|---|---|---|
| | 7 | 8 | 9 | 10* |
| SBR | 93 | 93 | 93 | 93 |
| Isocyanate 7 | 7 | | / | / |
| Isocyanate 8 | / | 7 | / | / |
| Isocyanate 9 | / | / | 7 | / |
| Isocyanate 10 | / | / | / | 7 |
| Isocyanate 11 | / | / | / | — |
| Tensile Strength | 54.1 | 117.2 | 121.1 | 51.7 |
| (psi) | | | | |
| Elongation % | 52.0 | 90.0 | 84.0 | 58.0 |

Further studies are required to define an optimum composite mixture but based on the limited data for compression-molded composites clear advantage with respect to tensile strength and elongation performance is observed for Composite 8 and 9 derived from Isocyanate Compositions 8 and respectfully.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1.) An isocyanate composition which comprises, based on total weight of the system:
a) from 50 to 95 weight percent of an isocyanate-terminated prepolymer composition having an average isocyanate content of from 1 to 15 weight percent, and
b) from 5 to 50 weight percent of a vegetable oil characterized by substantial absence of terminal functionality able to react with the isocyanate moiety of the prepolymer.

2.) The isocyanate composition of claim 1 wherein the vegetable oil is selected from the group consisting of soybean, safflower, corn, sunflower, linseed, coconut, cottonseed, palm, olive, rape, grape and peanut oils and mixtures of two or more thereof.

3.) The isocyanate composition of claim 2 wherein the vegetable oil is soybean oil.

4.) The isocyanate composition of claim 1 rendered moisture curable by the addition of catalytically effective amount of an amine or silane substance able to promote the reaction of isocyanate functionality with water or steam.

5.) A mixture suitable for compression molding or pour-in-place casting which comprises, based on total weight of the mixture:
a) from 75 to 95 percent of soybean, safflower, corn, sunflower, linseed, coconut, cottonseed, palm, olive, rape, grape and peanut oils and mixtures of two or more thereof,
b) from 5 to 25 percent of a moisture-curable isocyanate composition containing, based on amounts of (i) and (ii) present
i) from 50 to 95 weight percent of an isocyanate-terminated prepolymer composition having an average isocyanate content of from 1 to 15 weight percent, and
ii) from 5 to 50 weight percent of a vegetable oil characterized by substantial absence of terminal functionality able to react with the isocyanate moiety of the prepolymer.

6.) The mixture of claim 5 wherein the vegetable oil is selected from the group consisting of soybean, safflower, corn, sunflower, linseed, coconut, cottonseed, palm, olive, rape, grape and peanut oils and mixtures of two or more thereof,

7.) The mixture of claim 6 wherein the vegetable oil is soybean oil

8.) A process of forming a compressed cured material from a mixture comprising:
a) 75 to 97.5 weight percent of elastic or inelastic particles wherein the particles are of a size range of 0.1 to 15 mm;
b) 2.5 to 25.0 weight percent of a polymer binder, said process characterized in that the polymer binder is a moisture curable isocyanate composition containing
i) from 50 to 95 weight percent of an isocyanate-terminated prepolymer composition having an average isocyanate content of from 1 to 15 weight percent, and
ii) from 5 to 50 weight percent of a vegetable oil that is substantial devoid of terminal functionality able to react with the isocyanate moiety of the prepolymer.

9.) The process of claim 8 wherein the particles are of a substance selected from the group consisting of granulated rubber, polymerized ethylene-propylene diene, neoprene, granulated cork, granulated polyvinylchloride, granulated polyurethane, and granulated sawdust.

10.) The process of claim 9 which comprises placing the mixture in a mold and applying heat in a form of steam at a temperature between 110° C. and 140° C. and at a pressure between 3 to 8 bars and at a rate between 40 to 90 kg per hour to the mixture, and applying pressure of between 25 to 160 bars to the mixture to compress the mixture and effect a cure of the mixture and thus form the compressed cured material.

11.) The process of claim 8 wherein the vegetable oil present in the one-component polyurethane system is selected from the group consisting of soybean, safflower, corn, sunflower, linseed, coconut, cottonseed, palm, olive, rape, grape and peanut oils and mixtures of two or more thereof.

12.) The process of claim 11 wherein the vegetable oil is soybean oil.

13.) A composite article comprising particulate matter bound together by a cured polyurethane resin wherein said polyurethane resin is obtained by curing of the isocyanate composition as claimed in claim 1.

14.) The composite article of claim 13 being a roof or floor tile, or component of a sports track or playground surface, or recreational/hobby mat, or a traffic management object.
